(19) United States
(12) Patent Application Publication
(10) Pub. No.: US 2002/0034292 A1
(43) Pub. Date: Mar. 21, 2002

(54) System and a method to match demand and supply based on geographical location derived from a positioning system

(76) Inventors: Veijo M. Tuoriniemi, New York, NY (US); Cornelia F. Tuoriniemi, New York, NY (US)

Correspondence Address: VEIJO M. TUORINIEMI, 210 EAST 17TH STREET, APT 4D, NEW YORK, NY, 10003-3629, US

(21) Appl. No.: 09/935,152

(22) Filed: Aug. 22, 2001

Related U.S. Application Data
(60) Provisional application No. 60/226,956, filed on Aug. 22, 2000.
(60) Provisional application No. 60/248,164, filed on Nov. 13, 2000.
(60) Provisional application No. 60/240,897, filed on Oct. 17, 2000.

(51) Int. Cl. G01C 21/26

(52) U.S. Cl. 379/219; 701/213

(57) ABSTRACT

A computer assisted method, comprising steps of having a geographic location information, at least one demand parameter and a demand area definition parameter derived from a multiplicity of demand client computers. Storing said geographic location information, said demand parameters and said demand area definition parameter on a host server. Having a geographic location information, at least one supply parameter and a supply area definition parameter derived from a multiplicity of supply client computers.

Geographic location information said supply parameters and said supply area definition parameter are stored on a host server.

Searching matching supply parameters fulfilling said demand parameter within said demand area and delivering said supply parameters with optional location information, optional additional information and a contact means for each demand client computer by said host server.

Searching matching demand parameters fulfilling said supply parameter within said supply area and delivering said demand parameters with optional location information optional additional information and a contact means for each supply client computer by said host server.

This application claims priority from provisional applications 60/226,956 filed 08/22/2000, provisional application 60/240,897 filed Oct. 17, 2000 and provisional application 60/248,164 filed Nov. 13, 2000.

### FIELD OF INVENTION

Disclosed invention relates to computer programs, especially Internet based search engines used on portable telephone handsets. Program on a host server matches user-entered demand and user-entered supply based on user-given parameters and geographical location derived from a positioning system such as GPS (Global Positioning System) or given manually by a user by using a client computer. The host server calculates matching items, matching newly entered items and previously entered matching items arriving on the geographical search area. Matches are sent to a client computer and shown on a list or on a map of a cellular telephone handset.

### BACKGROUND OF THE INVENTION

### OBJECTS AND ADVANTAGES

Due to GSP system the search can be limited to an accurate, small area.

Both demand and supply can be mobile.

Service is user-driven. No unwanted advertisements or unwanted unsolicited contacts can be taken if user doesn't want it.

User can perform a continuous search, enabling new matching entries reaching the search area (e.g. circle around user) to be shown on a list or a map.

Disclosed system and programs are especially useful for a taxicab to find a customer, a truck to find a cargo or for a person seeking person-dating service.

Taxi reservation and emergency calls can be made without a dispatcher.

### DRAWING FIGURES

FIG. 1 shows a computer network system.

FIG. 2 shows additional ways to operate the computer network system.

FIG. 3 shows ways to input location, parameters and additional information and output information.

FIG. 4 shows a partial flow diagram of the search program.

FIG. 5a shows a front page of related one-button pre-determined searches and customizable searches.

FIG. 5b shows an additional information enter page.

FIG. 5c shows a virtual group form page.

FIG. 6 shows a taxicab's search page.

FIG. 7 shows a taxicab's search result on a map.

FIG. 8a shows a taxicab customer's confirmation screen.

FIG. 8b shows taxicab's screen after customers acceptance.

FIG. 8c shows taxicab's screen after customer's cancellation.

FIG. 8d shows enlarged screen.

FIG. 9a shows a search parameter-entering page for a dating service.

FIG. 9b shows a dating service's additional information entering page.

FIG. 10a shows dating service's found matching items on a list

FIG. 10b shows found matching items on a map.

FIG. 11 shows an information page with one touch contact buttons.

FIG. 12 shows a customer's information entering page to form a Taxi Group.

FIG. 13a shows taxi's search result page when Taxi Group customer search is on.

FIG. 13b shows taxi's result page after clicking customers Icon on screen 13a

FIG. 14 shows a virtual group entering page and additional information page.

FIG. 15 shows a flow diagram of formation of a virtual group.

FIG. 16 shows an aviation safety system based on GPS

FIG. 17 shows an upper view of two airplanes having their search areas equaling to a map shown on a computer screen.

FIG. 18 shows a map on a client computer screen of an airplane XY

### SUMMARY OF THE INVENTION

### DESCRIPTION PREFERRED EMBODIMENT

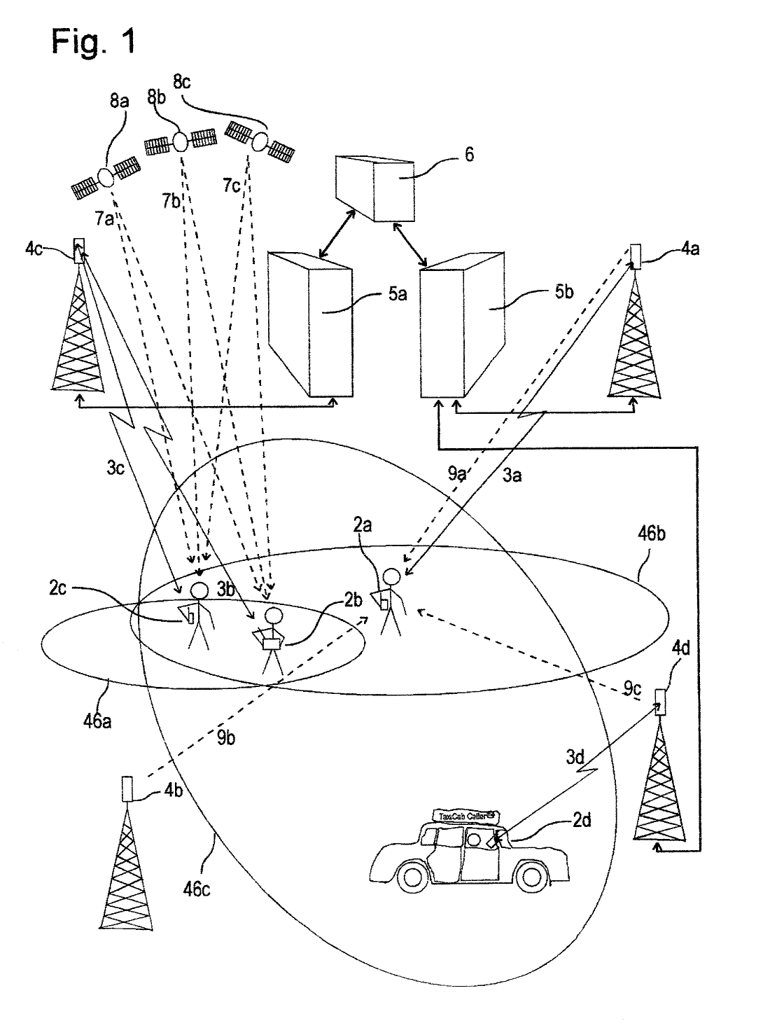

Computer system described in FIG. 1 has a plurality of mobile client computers 2 offering (supply) and mobile client computers 2 searching (demand) for a service or merchandise. Client computers 2 are connected to the telephone service provider transceivers 4 with a two-way wireless link 3. Network transceivers 4 are connected to a network server 5.

A plurality of network servers 5 is connected to the Host server 6. Host server 6 can be part of an individual telephone network, but it preferably serves plurality of networks.

Geographical position information of the client computer 2 is preferably derived and calculated from the GPS signals 7 from GPS satellites 8 or from network signals 9. User's position coordinates on a map are calculated preferably on the client computer 2 or telephone network server 5 and supplied to the host server 6 or they can be calculated on the host server 6.

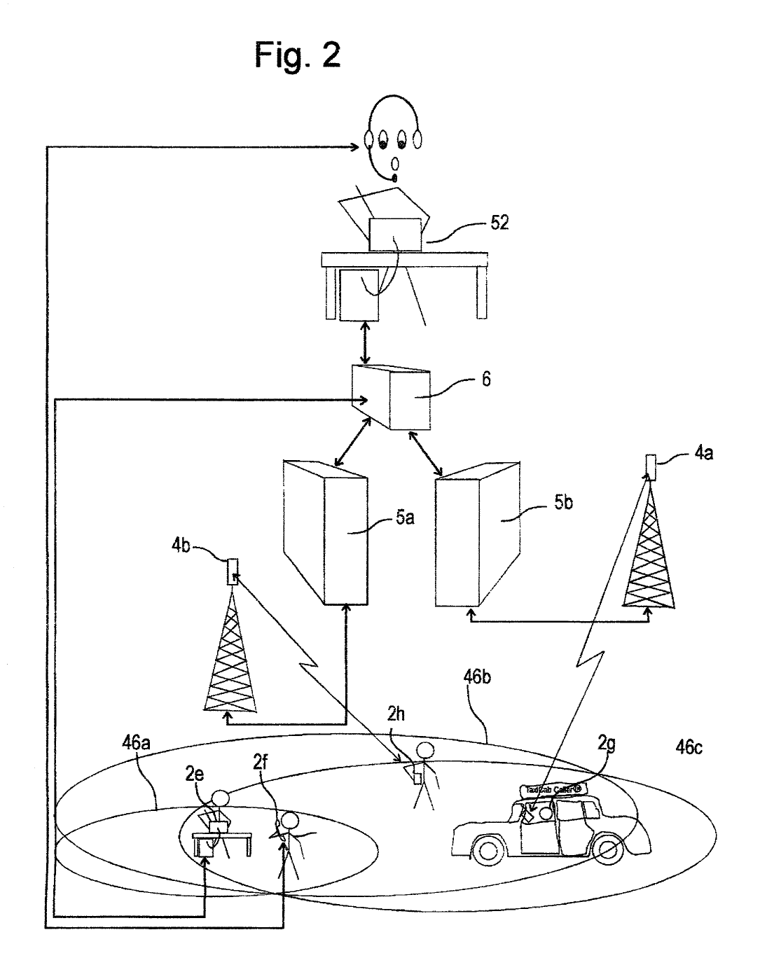

In FIG. 2 two alternative methods to enter location information, demand or supply parameters and search area parameters are shown. User 2c uses a personal computer to connect to the host server 6 by using a wired landline connection. Instead of deriving the geographic location information from a GPS system or a telephone network based location system, the user of the client computer enters his/her postal address manually. Computer program on the host server 6 translates the input address to map coordinates before performing the search.

When search is made the host server looks for matches for demand or supply within the demand and supply search area 46 and delivers the search results to the client computer(s) 2. If no matches, e.g. a taxi, are found within the search area 46a, user can extend the search area to 46b and make a new search. By extending the search area user increases his/her possibilities to find a supply source.

However, while the client 2c was executing a restricted area 46a search, the taxicab client 2g was performing search within the area 46c. He has been forwarded user 2e's request for a taxi and has an opportunity to contact 2e by a manner described later.

User 2f does not have a direct Internet connection to the Host server, but uses conventional telephone to call a dispatcher 52. Dispatcher 52 is in direct connection to a host server 6 and enters user 2f's address and user's contact telephone number. When the taxi 2g gets the request, he is shown user 2f's location on a map; users address as additional information and can contact user with his mobile phone anonymously as described below.

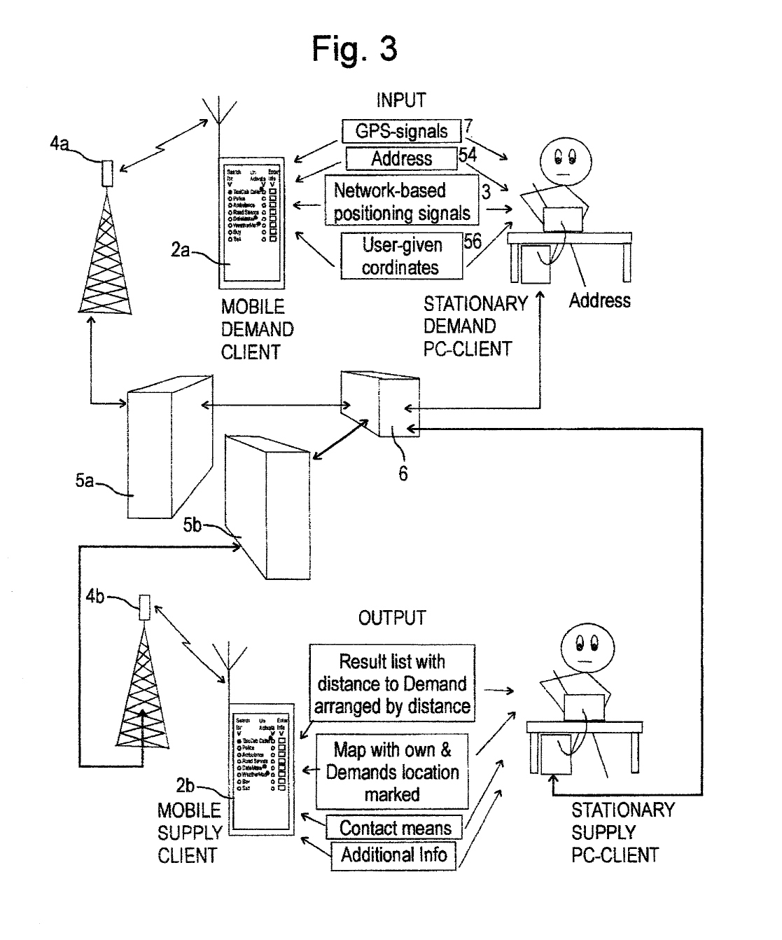

FIG. 3 describes ways to enter users geographic location information. Latitude/longitude coordinates can be derived from GPS signals or network based positioning signals. Different techniques are used to calculate user's position. Sirf Technology's GPS chip calculates the position on the telephone handset. Alternatively SnapTrack Inc.‘s’ GPS technology offloads much of the calculation work for the network server. However, it is understood that all systems which can produce latitude/longitude coordinates, which can be used to pinpoint user's location on a map on a computer screen can be used. When coordinates are derived from a given address or given coordinated, the location can be different than user's own location.

Some users might not want their location to be published or they might their location made unclear. Program on the host server can remove client computer's location from the map if desired, and not show the distance for other client computers. However, user's demand/supply request is shown on other parties' computers on desired manner, e.g. in the end of the search list Input consists also parameters as “taxi”, “police”, “woman 20-25”, “man 30-35”, “restaurant”, “movie-theater”, suggestion to form a game or playgroup. In some cases demand client can also be a supply client. A man 32 looking for a woman 25-30 is a demand client for a woman 25-30 but he is simultaneously supply for a woman 26 looking for a man 30-35. If desired the program can be programmed to have the man 32 be a supply for a woman 24 looking for a man 30-35, even if woman 24 is not included to man 32's search. Search results can be organized e.g. in two groups “matching items to your search” and “we are looking for you”.

The telephone number of a mobile telephone or PDA is given to the host server by the client computer automatically from telephone's ID string, or typing it manually to a dedicated entering box.

The given telephone numbers are anonymized on the host server 6 before distributing it to other client computers. The host server saves the given contact address for future use, but doesn't distribute the number to other client computers. When a user4 of a client computer wants to contact other client computer, the user presses a contact icon on a screen and the host server dials the number for the user without showing the callers telephone number to the called or called's number to the caller. Pull-technology enables contacting to other client computer without showing the number. First user can contact a second user when the second user is activated, e.g. when she/he is continuously searching or he/she is passively available. The same anonymisizing is also applied to a given pager, e-mail, instant messenger and voice mail address and numbers.

Well known anonymizing programs have been in use e.g. in Finland to anonymize e-mail addresses.

After the host server 6 has matched demand and supply, it delivers supply's location, supply parameters, e.g. woman-35, additional information and the contact means to the demand clients when supply client is within a demand client's search area. Host server also delivers demand client's location, demand parameters, additional information and the contact means to the demand clients if the demand client is within a supply clients search area.

Output results are shown on a list in a desired manner, e.g. listing results depending on the distance from the user. Alternatively results are pinpointed on a map. Map is provided by a client computer, Internet or the host server. Map is also scalable to show a search area or distance to a desired result, show driving directions to a result, or scalable to focus to a certain part on a search area. Several companies MapQuest Inc. among them provide scalable maps where a location can be pinpointed

Results comprise also additional information given by an other user and a one button anonymized contact means to contact other party.

Contacting party preferably pays contact expenses. In a case the contact will be higher than expected, e.g. contact is abroad, or telephone expense is otherwise high, the program should warn the user or optionally show the contact expense. 1-900 numbers should not be allowed unless contact allows his/her telephone number to be shown.

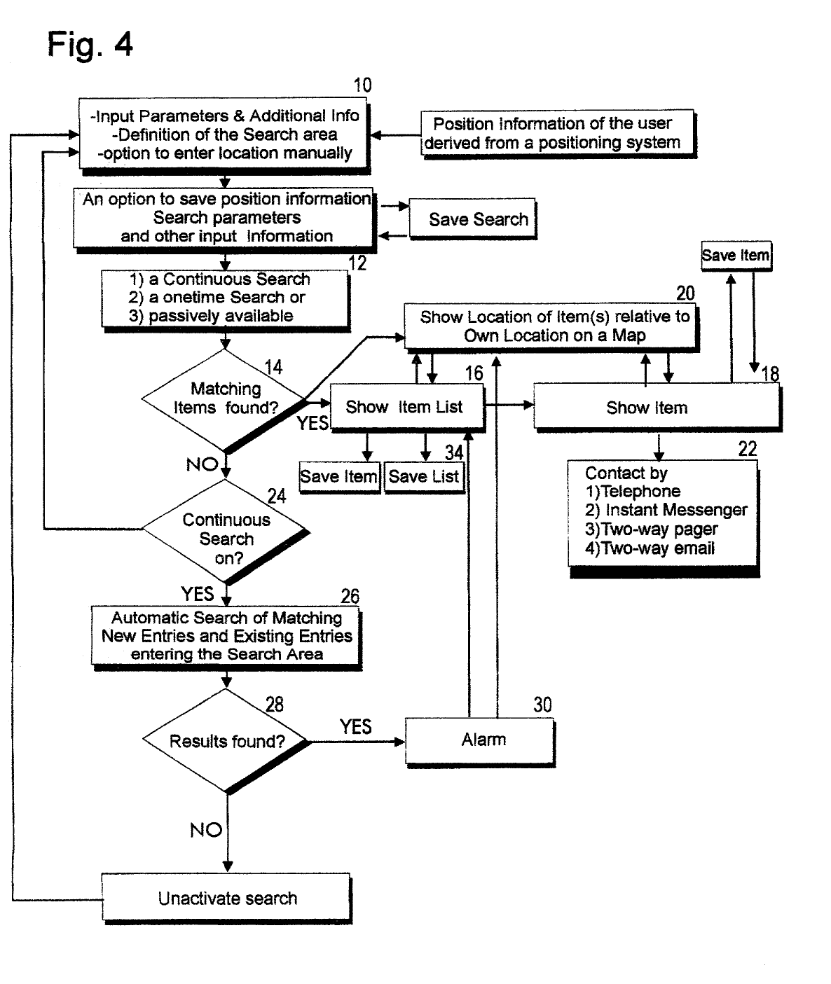

FIG. 4 shows a flow diagram of the program matching demand and supply.

10) User enters search parameters and contact information to a host server by using a client computer; WAP enabled telephone handset, PDA (Personal Digital Assistant) or by using Personal Computer (PC). Host server can be any Internet host server.

A user defines search area. Area can be e.g. “10 miles around user's current location.

Geographical location information is derived e.g. from the telephone's GPS-chip and it is forwarded to the host server.

Alternatively the position information can be given in text format by using a mark-up language like XML. The given position can be different than user's current position and the search can be performed around this location. The exact position can be given by entering the latitude and altitude coordinates if they are known. Alternatively the information is given by entering the postal address or a name of a city, state and the names of two crossing streets. By using entered information translated e.g. to XML language and sending it to a host server the position coordinates are derived and demand is entered to the search service.

If desired, the location can be saved as a location bookmark. The location bookmark can be given a name by the user and it can be saved on the server or the client computer. Search can be repeated by opening the bookmark and performing the search based on the bookmark's information. For example user can get current weather or a weather forecast around his/her summer cottage.

One option is that the connection to a host server is made and search is performed by using a personal computer. For example a customer or a taxi dispatcher can enter customers' address and telephone number on a host server. Customer icon will appear on a near-by taxicab's search screens. Taxi (supplier) can see customers (demand) location on a map and send a confirmation or contact him/her over the cellular telephone network.

12) After the parameters and location is entered a search is performed. Search can be a one-time activation of a service or a continuous search. During the continuous search user's position coordinates are updated to a host server after every predetermined time period. The connection to the host server is a continuously open line or the connection is re-established every pre-determined time period to update the location. If a user (supplier) doesn't want to perform a search he/she can enter his/her information and be passively available so that other users can contact him/her.

16) Search results (Items) are shown on a list in a desired order. The list can have e.g. the closest item listed first or it can have the newest item on the top of the list. The distance to the item can be calculated by the host server and shown as an addition to the information.

20) Search results are alternatively shown on a map, relative to user's current location. User's location is shown on a predetermined place on the map as a dot and search results are shown around it as small stars. This is default but at the same time an optional feature. Only those who accept to reveal their location are shown on a map. A user, who wants to avoid detailed information, can adjust the accuracy of the location information.

Whichever alternative, list or map was used last, pops up first. User can alternate between the list and the map and get more information from an item by clicking the item.

18) Individual item is shown when the headline on a search list is clicked or when a star representing customer's location is clicked on the map. Among standard information and contact means, an individual item can include additional e.g. visual information; photos and video, voice, written description, other parties search criteria etc.

22) User can contact item (demand or supply source) by using cellular telephone, two-way pager, instant messenger or e-mail through the host server. The contact is made anonymously (FIG. 11).

24) If continuous search is on, the host server continues to update location information and continues to find matches.

26) During continuous search the host server will alarm all new entries satisfying the parameters and existing entries arriving the search area. The computer also keeps updated about the movement of previously entered, matching entries. When an existing, matching entry enters the geographical search area, the system will alarm the user and show the entry on users item list and on a map

User has an option to save the Item List or an Item on the server or alternatively on client computer for future review.

### OPERATION OF THE FIRST EMBODIMENT

The invention matches a constantly travelling Supply and a travelling Demand. The service is ideal for e.g. Taxis to find a nearest customer.

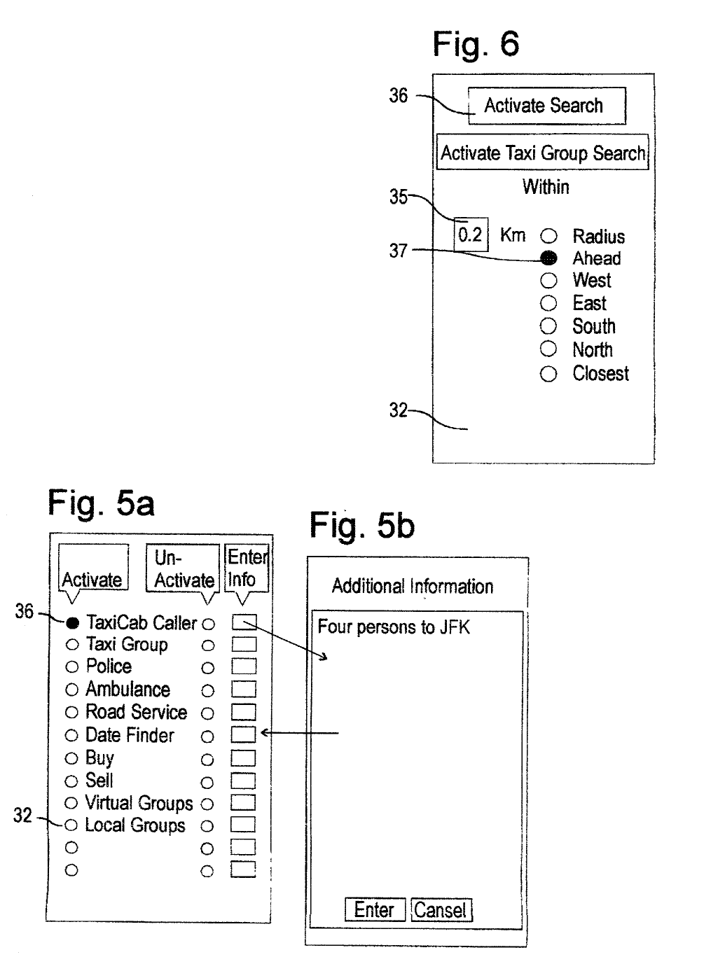

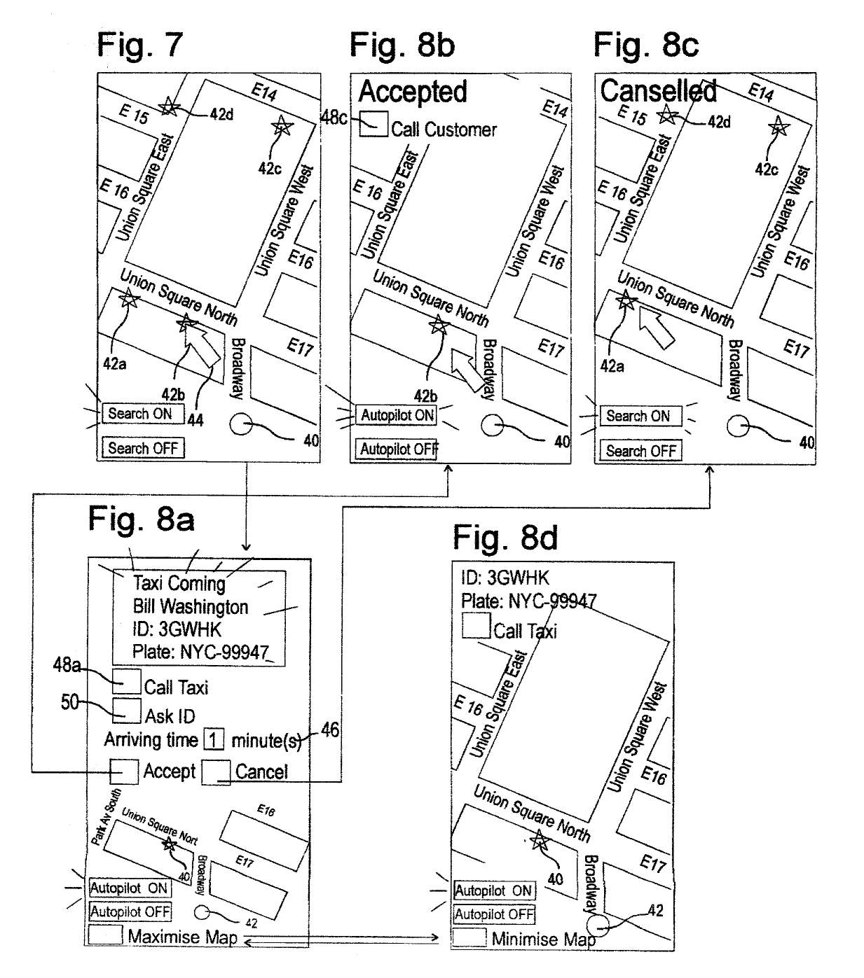

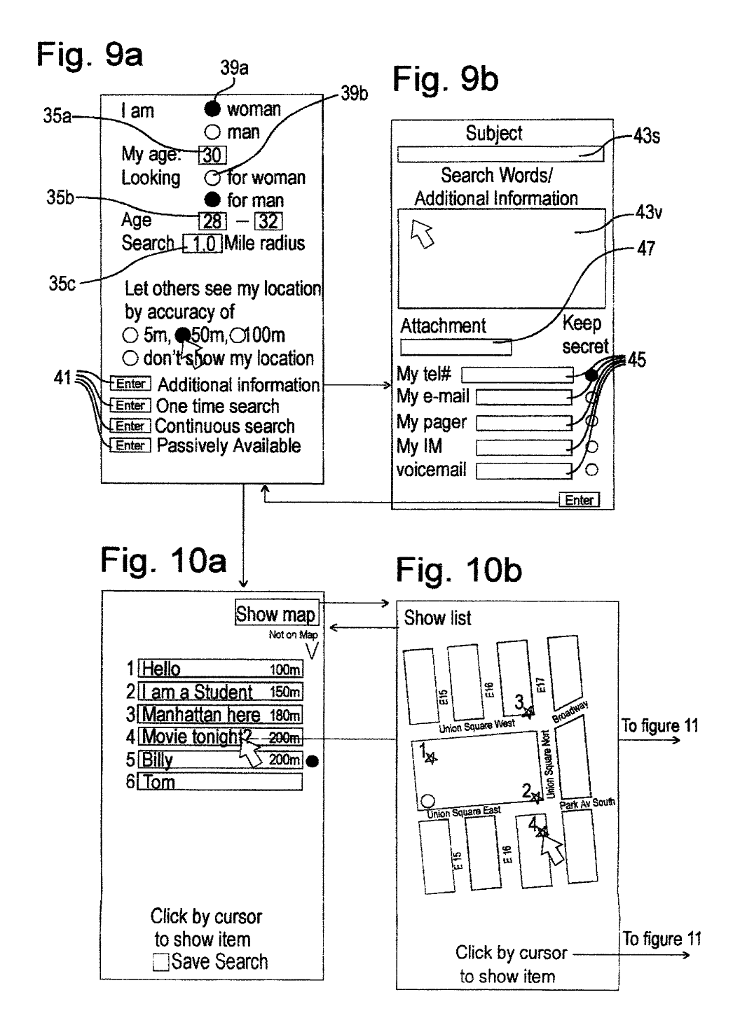

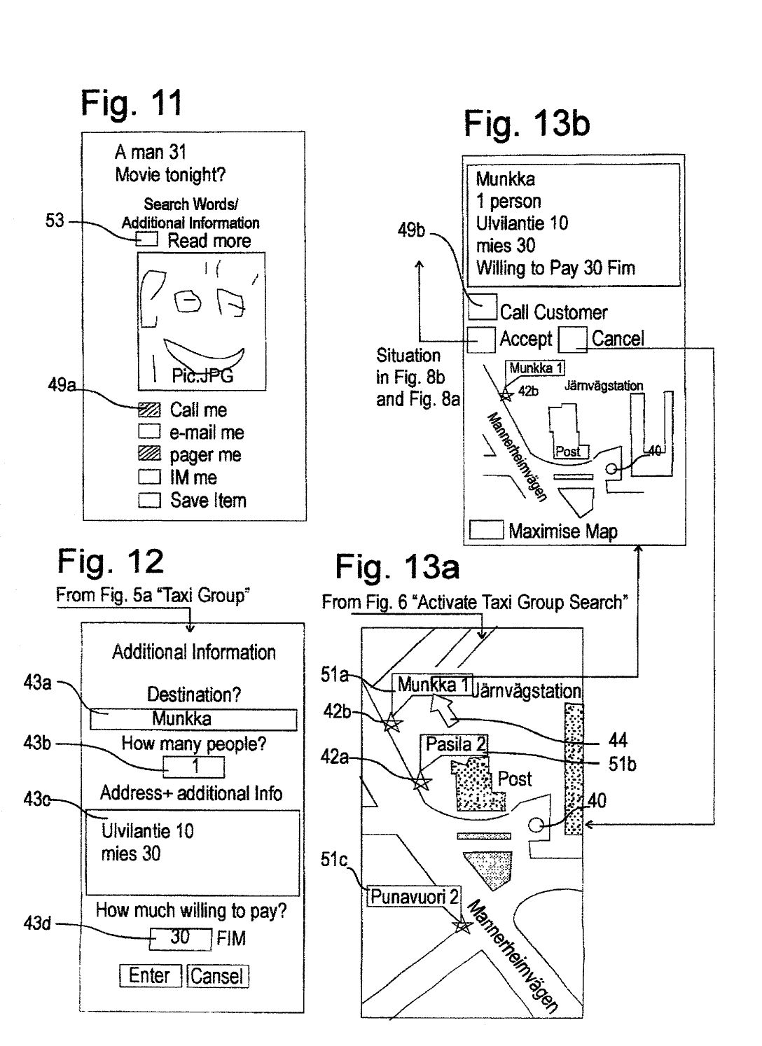

In the FIG. 5a a customer performs a simple one-button 36 search “Taxi” by clicking the icon 36 on a screen 32. The “Taxi” demand and the customer's location, which is derived from the GPS system, are sent to a host server by using telephone network. In FIG. 5b optional additional information 38 “four persons to JFK” is added. The additional information can be added before “Taxi” demand or during the activation of the service. Information is saved on the server. Pressing “Taxi” activates the service and enables the customer to show on taxi's search screen and search list.

A continuous search is performed. While customer is walking his/her position is updated for a server after every predetermined time.

In FIG. 6 a near by Taxi Driver performs a simple one-button search “Activate Search” 36 within “0.2 Miles” radius or has the continuous search on. The search is sent to a host server. A host server finds matches within the search area and sends matches with location information to taxicabs client computer.

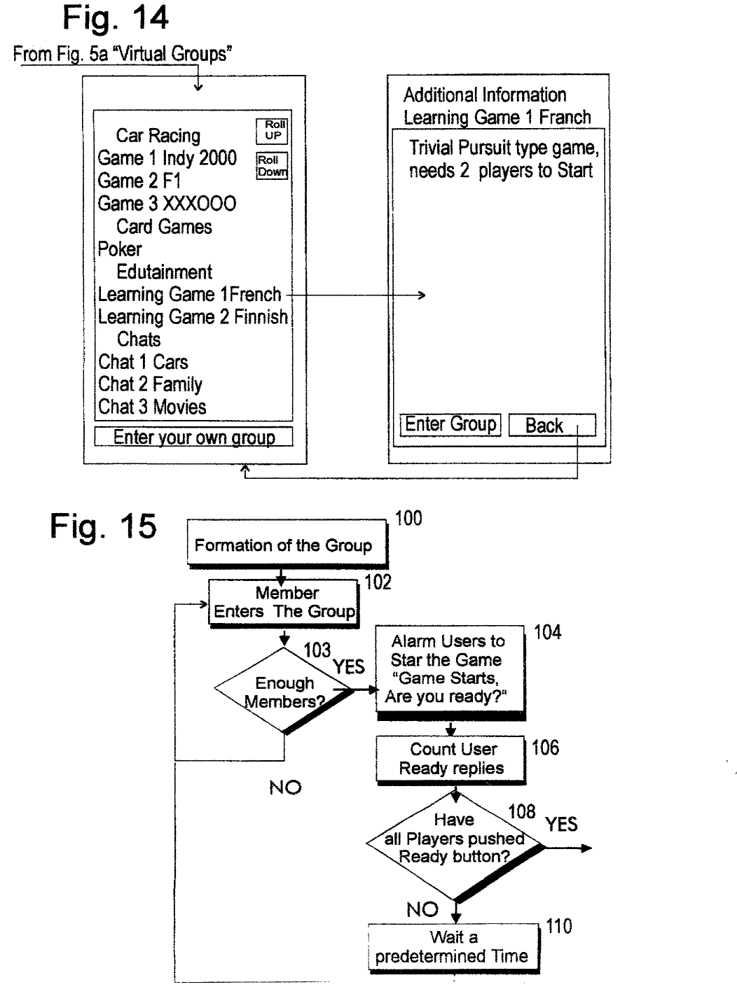

As a result the driver sees customer's locations on a map as showed in FIG. 7. In the lower part of the map the driver sees his/her own position 40 as a circle and all the customers icons 42 are spotted around him/her as stars. Driver moves a cursor 44 over the closest customer icon 42b and clicks it. If no additional information has been entered, clicking the star sends customer a “Taxi coming message”. If an additional information has been entered by the customer, the driver gets a pup-up menu with the information. Accepting the information sends customer a “Taxi coming” In FIG. 8a the customer gets the message sent by the driver. The customer see taxi's position on the map relative to his/her own position. After seeing taxicab's ID, location on a map and estimated arriving time 46 a customer accepts the “Taxi coming” message. Accepting removes him/herself from the general search service. The customer only shows on a map of the taxicab, whose offer he/she has accepted.

If customer cancels the taxi he/she will be removed from the service and taxi returns back to search (FIG. 8c).

FIG. 8b shows taxi's screen after customer has accepted his/her offer. Taxi and customer has been removed from a general search. Both parties only see their own and other party's position on a map approaching each others. However, the host server receives new location information and keeps updating both of the client computers about each other's location and locations are updated on each client computer's maps. Customer and a driver have their ID and contact information saved on a host server. Both parties can contact each other's anonymously by clicking the “Call” icon 48 e.g. to get more detailed driving directions.

In the end of the ride the taxi fare can be paid e.g. by transferring money wirelessly between the customer's telephone and the driver's telephone (not shown) Wireless connection between the phones can be established by using e.g. Bluetooth technology developed by Ericsson, IBM, Nokia and several other companies. Several methods can be used to perform the transfer. For example the fare can be paid by transferring credit card information or it can be paid by transferring electronic money. However, it might be tempting for a taxi customer to jump in an other taxi, which is faster to get and vice versa for an outsider taxi to lure customer to have a ride. In these cases the cabdriver using taxicab caller system looses a valuable time and money. However, by using a Bluetooth technology, a program can be made to require the devices handle together and verify identity information on a host computer. If identity verifying doesn't happen because the parties doesn't meet in short distance required by Bluetooth technology, either one of both parties are made economically responsible for the lost fare and predetermined amount of money is transferred electronically or charged in telephone bill.

Several methods to make payments have been developed and are known in the industry.

For security reason either customer or driver can have their position updated on a server during the drive. In emergency cases either one can alarm e.g. 911 by pressing predetermined icon or button(s) or releasing a predetermined button. Alarm button is programmed to alarm nearest ambulance or police or both connected to a service working same way as taxicab caller described above.

Ambulance and police that are connected to a service have continuous search open for alarms. Whenever alarm is sent from a telephone on their predetermined search area the map shows the location of the caller related to their location similar way than taxi driver gets customers location enabling a fast response to the alarm. Emergency personal can contact the person immediately by using the phone as taxi driver can contact his/her customer without the dispatcher.

A user has an option to save additional information for alarm cases on a host server or his/her client computer. User's medical history, profession (e.g. taxi driver), age, address, contact information, e.g. can be saved for to be released for an authorized professionals like ambulance drivers, doctors and police.

The above-described invention can be used to call for a taxi service, alarm police, alarm ambulance or fire department. It can be also be used by hitchhikers to get a drive, order food from a restaurant to a place having no address like to a park. The service can also be used between two people to find a date.

Under Date option in FIGS. 9a and 9b us user inputs search parameters as

Gender: “I am a woman”, My age: “30”, Looking for: “man”, Age: “28-32”

Search area: “1 mile” radius (Location derived from GPS)

Optionally the location given manually the way as described above (not shown).

On page shown in FIG. 9b, a user is also given an option to write additional text, subject, attach files and give a contact address.

Back on page in FIG. 9a user can dim his/her position if desired with predetermined accuracy.

Map Accuracy: o 5 meters, o 50 meters, o 100 meters o do not show me on a map.

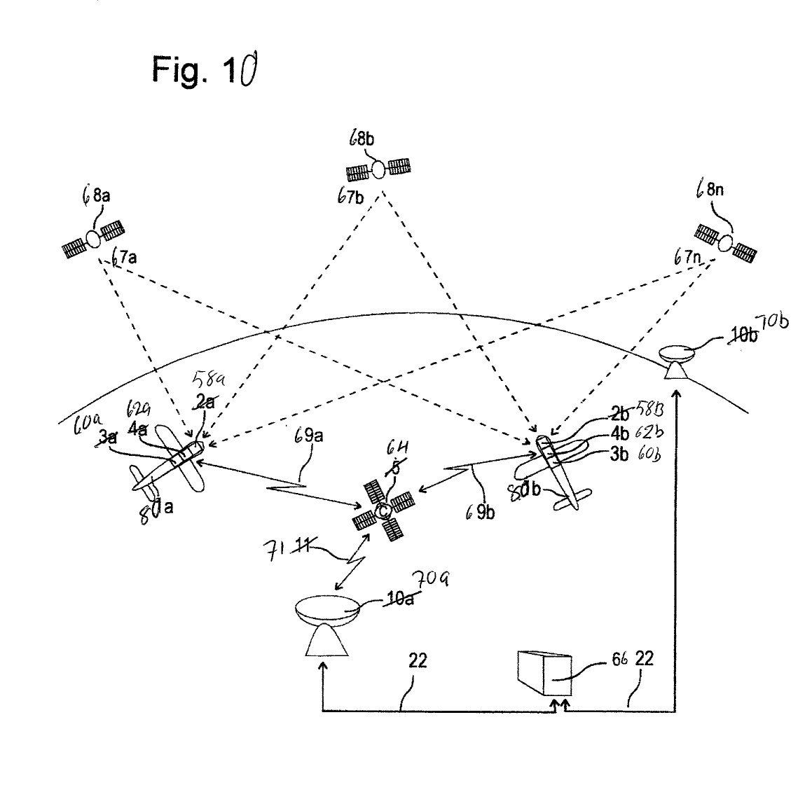

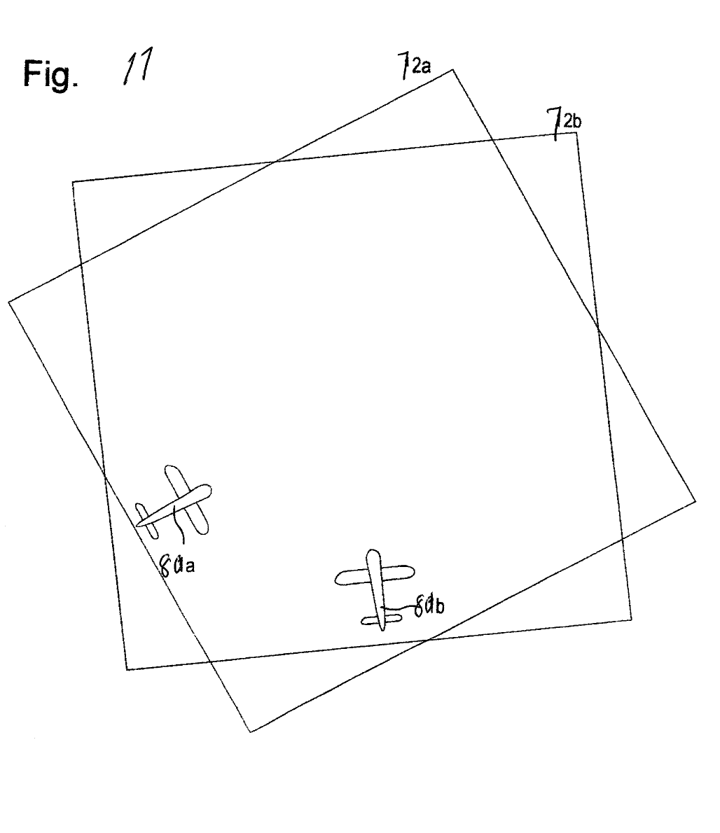

The information of a person looking for a date is saved on a server and activated for to get response. If a matching person located on a search area e.g. “a man, 31 years old, looking for a woman 25-35”, is found, or multiplicity of items are found, they are show on a list preferably listed by distance from a user as shown in FIG. 10a. Items can also be optionally localized on a map on predetermined accuracy determined by user as shown in FIG. 10b. If either the star on the map is clicked or the subject on the list is clicked, user gets additional information about the person she is interested.

Additional information page is shown in FIG. 11. Information can include e.g. text, pictures, video or audio. User is also given an opportunity to contact other party anonymously by telephone, two-way e-mail, two-way pager or by using an instant messenger. WAP Push technology is used to make the connection without showing the contact address.

When the contact is made, the counterpart is alarmed and he/she is shown the caller's parameters and additional information and given an option to answer to the contact or ignore it.

FIG. 12 shows a start page for a user to form a local group, in this case a “Taxi-group”, a group of people travelling to the same direction. User enters his destination in box 43a, the quantity of people travelling to that destination in box 43b, additional information; address and how much he is willing to pay are entered in boxes 43c and 43d. Continuous search is performed by pressing enter.

A near by taxi having a fare asks customer if he/she want to share expenses with a person travelling to the same direction. After getting acceptance driver activates Taxi Group Search (FIG. 6). In FIG. 13a the driver 40 gets all users 51 wanting to join a Taxi Group pinpointed around him. Additionally user's 51 destination and quantity of people are shown. The taxi driver click icon 51c by a cursor 44 or alternatively dictates “munkka 1” through a voice recognition program.

As a result in FIG. 13b the drives is shown user's additional information as address where the user is travelling and how much he/she is willing to pay. The driver is given also option to call user, accept or cancel the fare. Canceling takes driver back to the continuous search screen 13a where new customers are entered and customers are continuously arriving to the search area. The driver might ask his customer “we have a fare ahead willing to pay 30 FIM, do you want to share it with me?” If the offer is accepted, the driver and a user get to the approach situation described in FIGS. 8a and 8b.

In FIG. 14 and 15 a method to form a virtual group is described. A user has an option to browse available groups shown in FIG. 14. By clicking the name “Learning Game 1 French” user gets a description page with an option to enter the group. After acceptance member enters 102 the group in host server's memory. A counter 103 counts the members. When desired quantity of players are reached the host computer alarm users 104 to start the game by ringing the telephone's puzzler. Users express their readiness by sending a message to a host server. A counter 106 counts the replies and whenever the players are all ready 108, the server stars the game. The server waits a predetermined time to get all the ready answers and then turns to a wait a new player 102.

Invention can be used to increase aviation safety, especially small airplane aviation by using GPS, Global Positioning System.In FIG. 10 GPS signals 67a, 67b and 67n from a multiplicity of GPS satellites 68a, 68b and 68n are received by a GPS receiver 58. Geographical position of the airplane 80 is derived from the GPS signals and calculated by a client computer 60. Aircraft unit which is fixed to a conventional aircraft platform, includes dual global positioning system (“GPS”) receivers for determining the aircraft's position (longitude, latitude), speed, altitude, and tracking. is described detailed in U.S. Pat. No. 5.714948 “Satellite based aircraft traffic control system” for Farrmakis et al. Feb. 3, 1998

User's position coordinates on a map are calculated on the client computer 60. Alternatively they can be calculated on the host server 66. An airplane location: latitude, longitude and altitude are sent to a host server 66 by satellite telephone 62 integrated to the on board system.

Two-way satellite telephone 62 connects to the satellite 68 using radio signals 67 Satellite communicates with the ground station 70 through a down link radio signals 71.

The Ground station 70 is connected to a host server 66. Host server 66 saves the information to a memory and distributes it to other client computers on the area.

Among the location information other additional information; Identification code, size of the airplane and travelling speed, contact information, e.g. telephone number are saved on a server and updated constantly by using a continuously open line or by contacting the server every predetermined time.

For example Code Division multiple Access (CDMA) technology developed by Qualcomm and service provided by Globalstar and Qualcomm Incorporation can be used to provide a high-speed two-way link between ground station70, satellite 68 and an aircraft 80. Additionally, telephone service, e-mail and downloading of maps can be integrated to the system. Internet technology is preferred.

Telephone call connecting to a nearby aircraft can be made by employing a pull technology and providing pilot an opportunity to take contact by clicking the icon of the aircraft on a screen.

The speed of the airplane is derived from a speedometer or comparing the distance of two-location point to the consumed time between those to points.

Approximate future travelling path is estimate from the previous history of the travelling path. Calculating of the speed and future travelling path can be either performed on a client computer or the host server.

Map is provided by a client computer, Internet or the host server. Map is scalable to focus to a desired part on an area. Alternatively the map is automatically scaling itself to show the area between aircraft and a desired e.g. destination location.

Other user's location and additional information as size and type of the air craft, speed and future travelling path on the area are distributed to a client computer 66 on the airplane 80 and shown on a map on the screen of a client computer.

Type and size of the aircraft are shown on screen as an icon, travelling direction and estimated future travelling route of the aircraft is shown as an arrow, speed of the airplane and altitude are shown as alphanumeric information in a same context with the icon.

Safety area where the search is performed and shown detailed is the area shown on a map of a client computer. Safety area refers to a map on a client computer screen. Detailed refers to icons on a map. By searching using certain parameters, additional information saved on the host server can be accessed and shown on the map. User can access information about other objects on the area, floating objects as boats on at the sea or moving vehicles on a ground can be derived from the host and shown on the map. Stationary objects on the ground as airport and emergency airports, tall buildings and towers can be saved on the host server. Also temporary possible dangerous situations as kite flying, hot balloon-flying areas can be saved ton the host computer. When the aircraft is getting closer of such objects the pilot is alarmed and object is highlighted on a map. Warning is given at least in a case when airplane is in obvious danger, e.g. flying too low.

### OPERATION OF THE PREFERRED EMBODIMENT

FIG. 11 shows two approaching airplanes 80a and 80b, each having its security area 72a and 72b determined by a pilot. The security area is preferably same as the area shown on a screen of an on-board client computer.

FIG. 12 shows a map 73 on the screen of a client computer on a board of the airplane 80b. Identification information with other possible additional information is shown as icon 74. Icon is provided with a pull technology known from WAP, which enables communication connection to the other plane by clicking the icon. By employing touch technology, the connection can be made by pressing the icon on a screen. Estimated future travelling paths and direction are shown as an arrow 76. Estimated travelling path of the airplane 76c is shown on a map, even if the aircraft doesn't show on a map yet. The location of a high ground object 78 and airport 79 are delivered from the host computer and shown on a map.

### CONCLUSION, RAMIFICATIONS AND SCOPE

Even if the GPS is preferred, the location information can be also derived from a cellular telephone network based location system or other satellite based positioning system.

Described air-control system can be used on sea navigation and Truck Fleet navigation, especially outside of the cellular telephone coverage area.

### LIST OF REFERENCE NUMERALS

2 supply/demand client computer, mobile user

3 wireless link

4 network transceiver

5 network server

6 host server

7 GPS signals

8 GPS satellite

9 network signals

10 Input of Parameters to a server

12 Search

14 Matching Items found?

16 List of found Items

18 Individual item with optional additional information

20 Map showing Item(s) location

22 Contacting Item

24 Continuous Search on?

26 Automatic Search or New entries and existing entries entering the search area

28 A new Item(s)

30 Alarming user about the new Item

32 Option to see the new Item(s)

34 Save Item

35 User adjustable parameter

36 One Button search

37 Search option

38 additional information

39 Parameter, user selectable

40 own position

41 Search type

42 Found Items positioned on a map

43 Free text entering area

44 Cursor

45 Contact Info area

46 supply/demand search area

47 select file to be attached

48 call other party

49 contact icon to contact other party

50 Asking additional Information

51 Show destination

52 taxi dispatcher

53 Search worlds, additional information

54 user given address

56 user given coordinates

57

58 GPS receiver

60 Client Computer

62 satellite telephone

64 satellite

66 host server

67 GPS signal

68 GPS satellite

69 radio signals

70 ground station

71 down link radio signals

72 security area shown on a map of an on-board client computer.

73 map

74 Identification information and contact means

76 future travelling path and travelling direction

78 high ground object

79 airport

80 airplane

We claim

1. A computer assisted method, comprising steps of:
Having a geographic location information, at least one demand parameter and a demand area definition parameter derived from a multiplicity of demand client computers;
storing said geographic location information, said demand parameters and said demand area definition parameter on a host server;
having a geographic location information, at least one supply parameter and a supply area definition parameter derived from a multiplicity of supply client computers;
storing said geographic location information, said supply parameters and said supply area definition parameter on a host server;
searching matching supply parameters fulfilling said demand parameter within said demand area and delivering said supply parameters with optional location information, optional additional information and a contact means for each demand client computer by said host server;
searching matching demand parameters fulfilling said supply parameter within said supply area and delivering said demand parameters with optional location information optional additional information and a contact means for each supply client computer by said host server;

2. A computer assisted method of claim 1 wherein said geographic location information is constantly changing and derived from a GPS system.

3. A computer-assisted method of claim 2 wherein map coordinates, based on said continuously changing geographic information is calculated on said host server.

4. A computer assisted method of claim 1 wherein said geographic information is continuously changing and derived from Telephone network positioning system.

5. A computer assisted method of claim 1 wherein a user gives said geographic location information.

6. A computer assisted method of claim 5 wherein said geographic location information is given as map coordinates.

7. A computer assisted method of claim 5 wherein said geographic information is given as a postal address and modified as map coordinates by a dedicated program.

8. A computer assisted method of claim 7 wherein said given postal address is modified as map coordinates on said host server.

9. A computer assisted method of claim 7 wherein said postal address is entered through a PC client server.

10. A computer assisted method of claim 7 wherein said given postal address is given by a dispatcher.

11. A computer assisted method of claim 1 wherein said geographic location information can be given a name and saved for future.

12. A computer assisted method of claim 1 wherein said geographic location of a user of a client computer distributed to other client computer users can be dimmed.

13. A computer assisted method of claim 1 wherein said geographic location information derived from a first client computer, optional additional information and a contact means are delivered for at least one other client computer and said location of said first client computer is pinpointed on a map of the client computer.

14. A computer assisted method of claim 13 wherein said map is provided by host server.

15. A computer assisted method of claim 13 wherein said map is provided by an Internet server.

16. A computer assisted method of claim 13 wherein said map is resident of a client computer.

17. A computer assisted method of claim 1 wherein said distance of a geographic location information given by a supply client computer and geographic location information given by a demand client computer in measured on a host servers and distributed to either or both of the computers.

18. A computer assisted method of claim 1 wherein said demand and supply parameters are chosen by a user of a client computer.

19. A computer assisted method of claim 1 wherein said demand and supply parameters are constant.

20. A computer assisted method of claim 1 wherein optional additional freestyle information can be given by a user of a client computer.
